(19) United States
(12) Patent Application Publication
(10) Pub. No.: US 2007/0041867 A1
(43) Pub. Date: Feb. 22, 2007

(54) Urinary Diagnosis process

(76) Inventor: Alex Guan, La Puenta, CA (US)

Correspondence Address: Raymond Y. Chan, 108 N. Ynez Ave., #128, Monterey Park, CA, 91754, US

(21) Appl. No.: 11/206,457

(22) Filed: Aug. 17, 2005

(51) Int. Cl. G01N 31/22

(52) U.S. Cl. 422/56

(57) ABSTRACT

A urinary tester for tested urine includes a reference holder and at least two urine testing pads. The reference holder has a color result reference for displaying a test reference. The urine testing pads are spacedly extended from the reference holder, wherein each of the urine testing pads has a urine absorbing portion containing an urine testing substance and extending for absorbing the tested urine to be tested by the urine testing substance, such that the urine testing substance is adapted for chemically reacting with the tested urine to generate a coloring test result to be conveniently and instantly compared with the color result reference on the reference holder for correctly interpreting the coloring test result.

### BACKGROUND OF THE PRESENT INVENTION

1. Field of Invention

The present invention relates to a testing device, and more particularly to a urinary tester which allows a user to test urine specimen and inspect the testing result in a convenient and instant manner without the need of preparing a separate equipment, such as a piece of independent color result or references.

2. Description of Related Arts

Urine is one of the most important specimens which may obtain from human for testing the condition of health. For example, one may test specified type of Glucose contained in urine specimen in order to preliminarily assess the severity of diabetes and possibly, the extent of kidney failure.

There are several types of conventional urine testing pads currently use in hospitals, laboratories, or by medical researchers. First, there exist urine strips (dry chemistry dipsticks) each of which comprises a plurality of test pads in a single strip for testing a corresponding number of health parameters. For example, the test pads may be specifically provided for testing particular forms of glucose, proteins and the likes. A remarkable feature of this kind of urine strips is that a user needs to immerse the entire urine strip, which is as long as 10 cm, into urine specimen for testing the different health parameters by different test pads at the same time. The test pads are then compared with an independent color result reference for interpretation of the test results.

A major disadvantage of this first kind of urine strips is that they are inconvenient when use. As a matter of fact, these urine strips are usually utilized by medical or health care professionals who are trained to safely and effectively test urine specimen using those urine strips.

Another disadvantage is that a separate color result or references must be used in order to provide any meaningful interpretation of the test results which are usually in the form of color change of the test pads. This is troublesome and sometimes time-consuming given the relatively large numbers of test pads in any one of those urine strips. In some occasions, cross-contamination or pollution may occur among the large amount of specimens or the test pads since each test pad may accidentally come into contact with other specimens.

Second, there exist multi Drugs-Of-Abuse (DOA) screen devices which are capable of testing predetermined varieties of antigen by using lateral flow chromatography. The DOA screen device utilizes one step immunoassay to return a test result which is either positive or negative. An advantage of this type of DOA screen devices is that the test strips do not need to be entirely immersed into urine specimen. Instead, the user only needs to put the bottom of the relevant test strip into contact with sufficient amount of urine specimen which is then absorbed into the relevant test pads on the corresponding test strips for performing the urine testing.

There is nothing inherently disadvantageous in the above-mentioned DOA screen devices except its limited applications. As a matter of fact, the above two kinds of conventional urine testing pads have been developed in such a way that they cater for different kinds of users, and there have been no attempt to resolve their respective disadvantages. For example, the intense carefulness required by users of the first kind of urine testing pads is usually justified by their professional status. However, one must bear in mind that within the medical profession, there exist numerous incidents that result from the carelessness of the relevant practitioners.

Besides mentioned points, the new home use device can also cut patients' medical cost and save the health resource for more emergence use. Accordingly, the need for minimizing the chance of potential test errors on the one hand while maximizing the accuracy and quality of each test on the other by minimizing the risk of cross pollutions or contamination continues to be a pressing problem which is to be addressed by all persons skilled in the relevant art.

### SUMMARY OF THE PRESENT INVENTION

A main object of the present invention is to provide a urinary tester which allows a user to test urine specimen and inspect the testing result in a convenient and instant manner without the need of preparing separate equipment, such as a color result reference.

Another object of the present invention is to provide a urinary tester, which can be widely used as a screen test for health states of patients, so as to particularly fit for home use in comparison with the conventional tester that must be carried out by health care professionals.

Another object of the present invention is to provide a urinary tester, which effectively performs different tests from the same source of urine specimen.

Another object of the present invention is to provide a urinary tester which is capable of effectively overcoming the above-mentioned disadvantages for the conventional urine testing pads so as to achieve a more accurate test result and minimize the chance or occurrence of careless tests.

Another object of the present invention is to provide a urinary tester, which overcomes the hygiene problem of the traditional tester so as to give the user more convenience to monitor his or her health states at lower cost and to save the health care resource for more emergency use.

Another object of the present invention is to provide a urinary tester which allows the user to perform urine test in domestic environment in a rapid and convenient manner, so that medical cost can be reduced and health care resource can be saved for other more emergency use.

Another object of the present invention is to provide a urinary tester which is easy to handle, easy and convenient to interpret and can be maintained in sound hygienic condition.

Another object of the present invention is to provide a method of testing urine using the urinary tester, so as to achieve a more convenient home test result and minimize the chance or occurrence of careless tests.

Accordingly, in order to accomplish the above objects, the present invention provides a urinary tester for tested urine, comprising:

a reference holder having at least two color result references; and

at least two urine testing pads spacedly extended from the reference holder to align with the color result references respectively, wherein each of the urine testing pads has an urine absorbing portion for absorbing the tested urine and an urine testing substance formed on the urine absorbing portion for chemically reacting with the tested urine absorbed at the urine absorbing portion to generate a coloring test result to be conveniently and instantly compared with the respective color result reference on the reference holder for correctly interpreting the coloring test result.

Moreover, the present invention also provides a method of testing urine, comprising the steps of:

(a) providing a reference holder having at least two color result references, wherein at least two urine testing pads are spacedly extended from the reference holder to align with the color result references respectively;

(b) immersing urine absorbing portions of the urine testing pads into the tested urine so as to absorb the tested urine at the urine absorbing portions, wherein urine testing substances are provided on the urine absorbing portions of the urine testing pads respectively;

(c) generating a coloring test result when the urine testing substance is chemically reacted with the tested urine absorbed at the urine absorbing portion of each of the urine testing pads; and

(d) instantly comparing the coloring test result with the respective color result reference on the reference holder for correctly interpreting the coloring test result.

These and other objectives, features, and advantages of the present invention will become apparent from the following detailed description, the accompanying drawings, and the appended claims.

### BRIEF DESCRIPTION OF THE DRAWINGS

FIG. 1 is an exploded perspective view of a urinary tester according to a preferred embodiment of the present invention.

FIG. 2 is a schematic diagram of the urinary tester according to the above preferred embodiment of the present invention.

FIG. 3 is a first alternative mode of the urinary tester according to the above preferred embodiment of the present invention.

FIG. 4 is a second alternative mode of the urinary tester according to the above preferred embodiment of the present invention.

FIG. 5 is a schematic diagram of a method of testing urine using the urinary tester according to the above preferred embodiment of the present invention.

### DETAILED DESCRIPTION OF THE PREFERRED EMBODIMENT

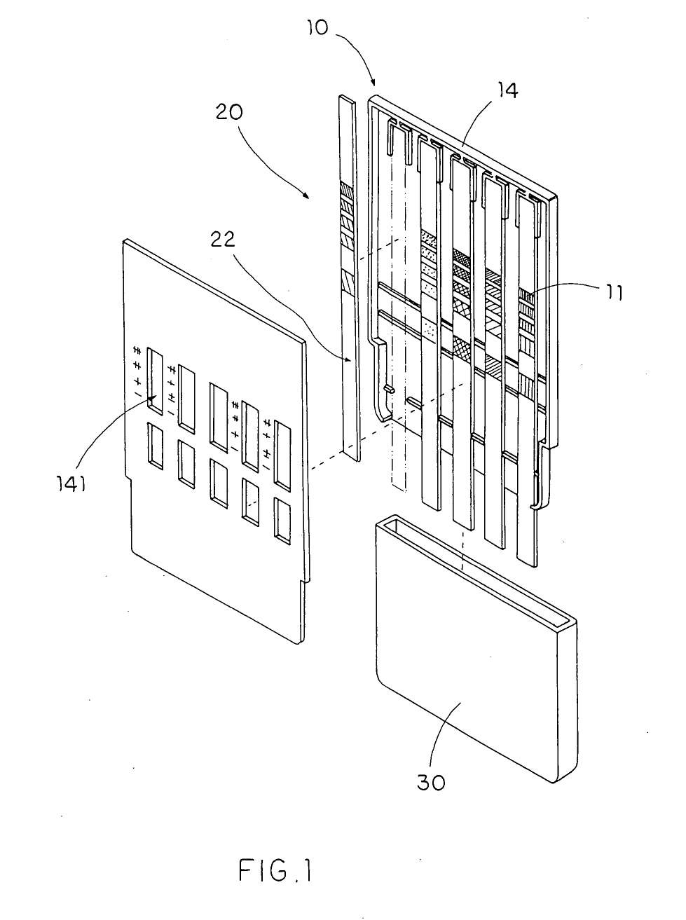

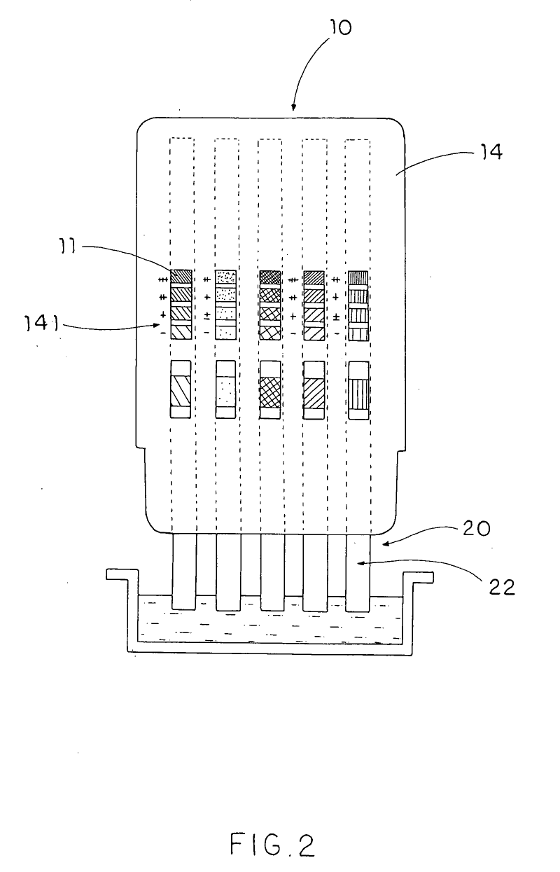

Referring to FIG. 1 to FIG. 2 of the drawings, a urinary tester for testing urine according to a preferred embodiment of the present invention is illustrated, in which the urinary tester comprises a reference holder 10 and a plurality of urine testing pads 20.

The reference holder 10 has a color result reference 11 which a user of the present invention may read and compare so as to correctly interpret any test result achieved from the urinary tester of the present invention.

The urine testing pads 20 are spacedly extended from the reference holder 10 to align with the color result references 11 respectively, wherein each of the urine testing pads 20 has an urine absorbing portion 22 for absorbing the tested urine and an urine testing substance formed on the urine absorbing portion 22 for chemically reacting with the tested urine absorbed at the urine absorbing portion 22 to generate a coloring test result to be conveniently and instantly compared with the respective color result reference on the reference holder for correctly interpreting the coloring test result.

According to the preferred embodiment of the present invention, each of the urinary testers 20 is elongated in shape forming the urine absorbing portion 22 extended from the reference holder to contact with the tested urine, wherein the urine testing substance is received in the reference holder 10 for testing the tested urine absorbed by the urine absorbing portion 22.

The reference holder 10 comprises a pad housing 14, having a plurality of color reference slots 141 for displaying the color result reference 11, spacedly mounting the urine testing pads 20 thereto at a position that the urine absorbing portions 22 of the urine testing pads 20 are outwardly extended from the pad housing 14 and are aligned with the color result reference. As such, the coloring test result can instantly and conveniently be compared with the color result reference for correctly interpreting the coloring test result for accurate and informative use thereof.

The reference holder 10 preferably forms as a planar structure for convenient use and carrying, wherein the color result reference 11 is formed thereon for indicating the test reference for the relevant urine testing pad 20. According to the preferred embodiment, the reference holder 10 has a corresponding number of color result reference 11 as the number of the urine testing pads 20 so as to indicate different test reference for each different urine testing pad 20. Referring to FIG. 1 and FIG. 2 of the drawings, the color result references 11 are spacedly provided on the reference holder 10 at positions corresponding to the urine testing pads 20 respectively, wherein each of the color result references 11 contains a plurality test references and test scales for indicating a particular meaning of each of the test reference. For example, a test reference in green color may indicate that the tested urine has a PH value in the range of about 7.

Thus, the urine testing pads 20 are alignedly and spacedly supported on the reference holder 10 for clearly and unambiguously differentiating different coloring test results of different tests performed on the tested urine, wherein the color result reference 11 is correspondingly positioned on the reference holder 10 with respect to the corresponding urine testing pad 20 so as to optimally accommodate a correct interpretation of the coloring test result provided on the corresponding urine testing pad 20. No extra effort (e.g. obtaining a separate standard color result reference or spectrum) on the part of the user is required to interpret the coloring test result.

According to the preferred embodiment of the present invention, each of the urine testing pads 20 is formed in a strip member having a bottom portion defining the urine absorbing portion 22, an upper portion forming the respective color result reference 11, wherein the urine testing substance is carried on the urine absorbing portion 22 at a position close to the color result reference 11, such that the coloring test result is formed at the urine absorbing portion 22 of the urine testing pad 20 to conveniently and instantly compare with the color result reference 11 at the upper portion of the urine testing pad 20.

In order to obtain sufficient amount of tested urine, each of the urine testing pads 20 is adapted to absorb tested urine by the principle of lateral flow chromatography from the urine absorbing portion 22 to the testing substance so that only the urine part of the absorbing portion 22 is required to immerse into the tested urine for drawing urine therefrom up to the testing substance. In other words, the tested urine is absorbed by the urine absorbing portions 22 of the urine testing pads 20 by lateral flow chromatography to perform different tests at the same time.

Each of the urine testing pads 20 is designed to test different attributes from the same tested urine. For example, the urinary tester may be specifically designed to cater for diabetes sufferers so that the urine testing pads 20 may be designed to test different parameters such as Glucose, Proteins, pH value, etc.

Referring to FIG. 1 and FIG. 2 of the drawings, the urinary tester further comprises a protection cap 30 detachably mounted on a bottom portion of the reference holder 10 so as to protectively yet detachably enclose the urine absorbing portion 22 of the urine testing pads 20 within the protection cap 30 for preventing user of the present invention or other people from contacting with urine residuals absorbed on the urine absorbing portions 22 after any urine test has been carried out. Furthermore, the protection cap 30 is capable of shielding and protecting the urine absorbing portion 22 from pollution before performance of any urine test. In other words, the urine absorbing portions 22 of the urine testing pads 20 are normally shielded and enclosed until use so as to minimize preventable experimental errors of the urine test and to maximize a storage period of the present invention.

It is worth mentioning that the color result reference 11 can be permanently formed on the reference holder 10 for providing the test reference. Alternatively, the color result reference 11 can be provided on each of the urine testing pads 20, wherein the color result references 11 can be displayed though the color reference slots 141 respectively. Thus, the user is able to view the color result reference 11 on each urine testing pad 20 through the relevant color reference slot 141 on the reference holder 10. In other words, the reference holder 10 may fit a wide variety of urine testing pads 20 having different testing purposes in that the color result references 11 are optimally provided on individual urine testing pads 20 and not permanently on the reference holder 10.

According to the preferred embodiment, the urine testing pads 20 may be embodied as dry chemistry pads as well as one-step immunoassay dipsticks for performing a wide variety of different tests on the same tested urine. A remarkable feature of the present invention is that each of the urine testing pads 20 employs lateral flow chromatography for absorbing the tested urine.

In other words, at least one of the urine testing pads 20 contains chemistry reagent as the urine testing substance provided at the corresponding urine absorbing portion 22 of the respective urine testing pad 20 while another the urine testing pad 20 contains immunoassay as the urine testing substance provided at the urine absorbing portion 22 of the respective urine testing pad 20.

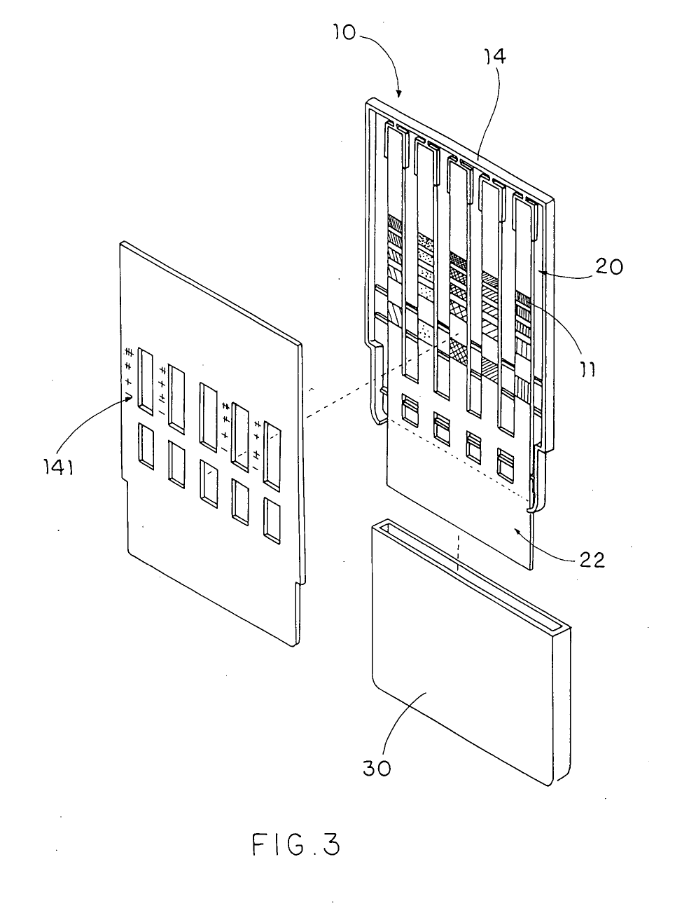

Referring to FIG. 3 of the drawings, as a first alternative of the present invention, the bottom ends of the urine testing pads 20 may be integrally extended to form a single urine absorbing membrane for absorbing the tested urine and distributing the tested urine to react with the urine testing substance of each of the urine testing pads 20 in a separated manner. Thus, a single urine absorbing membrane is utilized for accommodating different urine testing pads 20 for performing different tests.

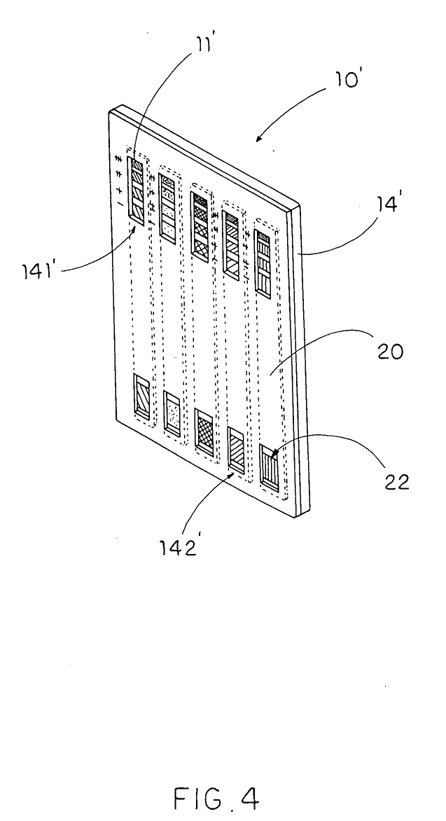

Referring to FIG. 4 of the drawings, a second alternative mode of the urinary tester according to the above preferred embodiment of the present invention is illustrated. The second alternative mode is similar to the preferred embodiment except the reference holder 10′. According to the second alternative mode, the reference holder 10′ comprises a pad housing 14′, having a plurality of color reference slots 141′ for displaying the color result references 11′ respectively, and a plurality of opening slots 142′ aligned with the color reference slots 141′ respectively, wherein the urine testing pads 20 are spacedly supported within the pad housing 14′ at a position that the urine testing substances of the urine testing pads 20 are aligned with the opening slots 142′ for chemically reacting with the tested urine when the opening slots 142′ of the pad housing are immersed under the tested urine. In other words, in this mode it does not use lateral flow chromatography principle to deliver the tested urine, it rather to use direct contacting of the urine testing pads 20 in parallel manner with the tested urine to deliver specimen.

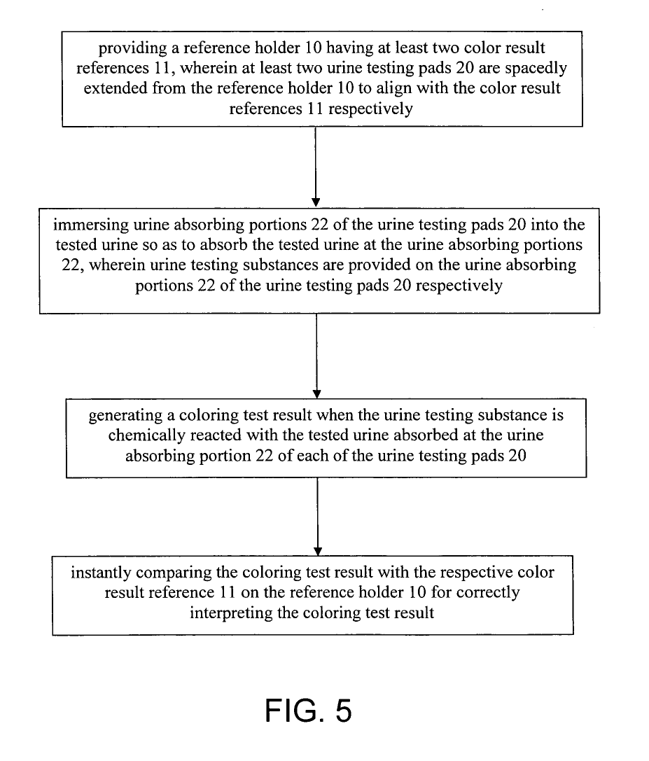

Referring to FIG. 5 of the drawings, a method of testing urine according to the preferred embodiment of the present invention is illustrated, in which the method comprises the steps of:

(a) providing a reference holder 10 having at least two color result references 11, wherein at least two urine testing pads 20 are spacedly extended from the reference holder 10 to align with the color result references 11 respectively;

(b) immersing urine absorbing portions 22 of the urine testing pads 20 into the tested urine so as to absorb the tested urine to the urine absorbing portions 22 of the two urine testing pads 20, wherein urine testing substances are provided at each of the urine absorbing portions 22 of the urine testing pads 20 respectively;

(c) generating a coloring test result when the urine testing substance is chemically reacted with the tested urine absorbed at the urine absorbing portion of each of the urine testing pads 20; and

(d) instantly comparing the coloring test result with the respective color result reference 11 on the reference holder 10 for correctly interpreting the coloring test result.

In step (b), after the urine absorbing portions 22 contact with the tested urine, the tested urine is absorbed and drawn to be tested by the principle of lateral flow chromatography for chemically reacting with the urine testing substance of the corresponding urine testing pads 20 so as to produce the coloring test result.

In step (d), since the color result reference 11 and the urine absorbing portion 22 of the corresponding urine testing pad 20 are readily available on the reference holder 10, a user can be able to instantly and conveniently compare the coloring test result with the test reference of the color result reference 11 for acquiring a proper interpretation of the coloring test result and at the meantime avoid messy.

As an alternative of the preferred embodiment, step (b) comprises the steps of:

(b.1) absorbing the tested urine by a single urine absorbing membrane integrally formed by the urine absorbing portions 22 of the urine testing pads 20; and

(b.2) distributing the tested urine to react with the urine testing substances at the urine absorbing portions 22 of the urine testing pads 20 in a separated manner for performing different tests on the different urine absorbing portions 22.

As an alternative of the preferred embodiment, the step (b) further comprises the steps of:

(b.1′) immersing the paralleled spaced opening slots 142′ into the tested urine, so as to absorb the tested urine to the urine testing pad 20, wherein urine testing substances are provided to react with the tested urine; and

(b.2′) generating a coloring test result when the urine testing substance is chemically reacted with the tested urine.

From the forgoing description, it can be shown that the above objects have been substantially achieved. The present invention successfully provides a urinary tester which allows a user to test urine specimen and inspect the testing result in a convenient and instant manner without the need of preparing separate equipment, such as a color result reference. Moreover, the present invention also provides a method of testing urine using the urinary tester, so as to achieve a more accurate test result and minimize the chance or occurrence of careless tests.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A urinary tester for tested urine, comprising:
a reference holder having at least two color result references; and
at least two urine testing pads spacedly extended from said reference holder to align with said color result references respectively, wherein each of said urine testing pads has an urine absorbing portion for absorbing said tested urine and an urine testing substance formed on said urine absorbing portion for chemically reacting with said tested urine absorbed at said urine absorbing portion to generate a coloring test result to be conveniently and instantly compared with said respective color result reference on said reference holder for correctly interpreting said coloring test result.

2. The urinary tester, as recited in claim 1, wherein at least one of said urine testing pads contains chemistry reagent as said urine testing substance provided at said urine absorbing portion of said respective urine testing pad while another said urine testing pad contains immunoassay as said urine testing substance provided at said urine absorbing portion of said respective urine testing pad.

3. The urinary tester, as recited in claim 1, wherein each of said urine testing pads is formed in a strip member having a bottom portion defining said urine absorbing portion and an upper portion forming said respective color result reference, wherein said urine testing substance is carried on said urine absorbing portion at a position close to said color result reference, such that said coloring test result is formed at said urine absorbing portion of said urine testing pad to conveniently and instantly compare with said color result reference at said upper portion of said urine testing pad.

4. The urinary tester, as recited in claim 2, wherein each of said urine testing pads is formed in a strip member having a bottom portion defining said urine absorbing portion and an upper portion forming said respective color result reference, wherein said urine testing substance is carried on said urine absorbing portion at a position close to said color result reference, such that said coloring test result is formed at said urine absorbing portion of said urine testing pad to conveniently and instantly compare with said color result reference at said upper portion of said urine testing pad.

5. The urinary tester, as recited in claim 1, wherein said reference holder comprises a pad housing, having a plurality of color reference slots for displaying said color result references respectively, spacedly mounting said urine testing pads thereto at a position that said urine absorbing portions of said urine testing pads are outwardly extended from said pad housing and are aligned with said color result references.

6. The urinary tester, as recited in claim 2, wherein said reference holder comprises a pad housing, having a plurality of color reference slots for displaying said color result references respectively, spacedly mounting said urine testing pads thereto at a position that said urine absorbing portions of said urine testing pads are outwardly extended from said pad housing and are aligned with said color result references.

7. The urinary tester, as recited in claim 4, wherein said reference holder comprises a pad housing, having a plurality of color reference slots for displaying said color result references respectively, spacedly mounting said urine testing pads thereto at a position that said urine absorbing portions of said urine testing pads are outwardly extended from said pad housing and are aligned with said color result references.

8. The urinary tester, as recited in claim 1, further comprising a protection cap detachably mounted on a bottom portion of said reference holder so as to enclose said urine absorbing portions of said urine testing pads within said protection cap for preventing said urine absorbing portions of said urine testing pads from exposure.

9. The urinary tester, as recited in claim 4, further comprising a protection cap detachably mounted on a bottom portion of said reference holder so as to enclose said urine absorbing portions of said urine testing pads within said protection cap for preventing said urine absorbing portions of said urine testing pads from exposure.

10. The urinary tester, as recited in claim 7, further comprising a protection cap detachably mounted on a bottom portion of said reference holder so as to enclose said urine absorbing portion of said urine testing pads within said protection cap for preventing said urine absorbing portion of said urine testing pads from exposure.

11. The urinary tester, as recited in claim 1, wherein said reference holder comprises a pad housing having a plurality of color reference slots for displaying said color result references respectively and a plurality of opening slots aligned with said color reference slots respectively, wherein said urine testing pads are spacedly supported within said pad housing at a position that said urine testing substances of said urine testing pads are aligned with said opening slots for chemically reacting with said tested urine when said opening slots of said pad housing are immersed under said tested urine.

12. The urinary tester, as recited in claim 2, wherein said reference holder comprises a pad housing having a plurality of color reference slots for displaying said color result references respectively and a plurality of opening slots aligned with said color reference slots respectively, wherein said urine testing pads are spacedly supported within said pad housing at a position that said urine testing substances of said urine testing pads are aligned with said opening slots for chemically reacting with said tested urine when said opening slots of said pad housing are immersed under said tested urine.

13. The urinary tester, as recited in claim 4, wherein said reference holder comprises a pad housing having a plurality of color reference slots for displaying said color result references respectively and a plurality of opening slots aligned with said color reference slots respectively, wherein said urine testing pads are spacedly supported within said pad housing at a position that said urine testing substances of said urine testing pads are aligned with said opening slots for chemically reacting with said tested urine when said opening slots of said pad housing are immersed under said tested urine.

14. The urinary tester, as recited in claim 1, wherein each of said urine testing pads contains chemistry reagent as said urine testing substance provided at said urine absorbing portion of said respective urine testing pad.

15. The urinary tester, as recited in claim 14, wherein each of said urine testing pads is formed in a strip member having a bottom portion defining said urine absorbing portion and an upper portion forming said respective color result reference, wherein said urine testing substance is carried on said urine absorbing portion at a position close to said color result reference, such that said coloring test result is formed at said urine absorbing portion of said urine testing pad to conveniently and instantly compare with said color result reference at said upper portion of said urine testing pad.

16. The urinary tester, as recited in claim 15, wherein bottom ends of said urine testing pads are integrally extended to form a single urine absorbing membrane such that said urine absorbing membrane is adapted for absorbing said tested urine and for distributing said tested urine to react with said urine testing substance of each of said urine testing pads in a separated manner.

17. The urinary tester, as recited in claim 14, wherein said reference holder comprises a pad housing, having a plurality of color reference slots for displaying said color result references respectively, spacedly mounting said urine testing pads thereto at a position that said urine absorbing portions of said urine testing pads are outwardly extended from said pad housing and are aligned with said color result references.

18. The urinary tester, as recited in claim 15, wherein said reference holder comprises a pad housing, having a plurality of color reference slots for displaying said color result references respectively, spacedly mounting said urine testing pads thereto at a position that said urine absorbing portions of said urine testing pads are outwardly extended from said pad housing and are aligned with said color result references.

19. The urinary tester, as recited in claim 16, wherein said reference holder comprises a pad housing, having a plurality of color reference slots for displaying said color result references respectively, spacedly mounting said urine testing pads thereto at a position that said urine absorbing portions of said urine testing pads are outwardly extended from said pad housing and are aligned with said color result references.

20. The urinary tester, as recited in claim 14, wherein said reference holder comprises a pad housing having a plurality of color reference slots for displaying said color result references respectively and a plurality of opening slots aligned with said color reference slots respectively, wherein said urine testing pads are spacedly supported within said pad housing at a position that said urine testing substances of said urine testing pads are aligned with said opening slots for chemically reacting with said tested urine when said opening slots of said pad housing are immersed under said tested urine.

21. The urinary tester, as recited in claim 15, wherein said reference holder comprises a pad housing having a plurality of color reference slots for displaying said color result references respectively and a plurality of opening slots aligned with said color reference slots respectively, wherein said urine testing pads are spacedly supported within said pad housing at a position that said urine testing substances of said urine testing pads are aligned with said opening slots for chemically reacting with said tested urine when said opening slots of said pad housing are immersed under said tested urine.

22. The urinary tester, as recited in claim 14, further comprising a protection cap detachably mounted on a bottom portion of said reference holder so as to enclose said urine absorbing portions of said urine testing pads within said protection cap for preventing said urine absorbing portions of said urine testing pads from exposure.

23. The urinary tester, as recited in claim 15, further comprising a protection cap detachably mounted on a bottom portion of said reference holder so as to enclose said urine absorbing portions of said urine testing pads within said protection cap for preventing said urine absorbing portions of said urine testing pads from exposure.

24. The urinary tester, as recited in claim 16, further comprising a protection cap detachably mounted on a bottom portion of said reference holder so as to enclose said urine absorbing portions of said urine testing pads within said protection cap for preventing said urine absorbing portions of said urine testing pads from exposure.

25. The urinary tester, as recited in claim 19, further comprising a protection cap detachably mounted on a bottom portion of said reference holder so as to enclose said urine absorbing portions of said urine testing pads within said protection cap for preventing said urine absorbing portions of said urine testing pads from exposure.

26. A method of testing urine, comprising the steps of:
(a) providing a reference holder having at least two color result references, wherein at least two urine testing pads are spacedly extended from said reference holder to align with said color result references respectively;
(b) immersing urine absorbing portions of said urine testing pads into said tested urine so as to absorb said tested urine at said urine absorbing portions, wherein urine testing substances are provided on said urine absorbing portions of said urine testing pads respectively;
(c) generating a coloring test result when said urine testing substance is chemically reacted with said tested urine absorbed at said urine absorbing portion of each of said urine testing pads; and
(d) instantly comparing said coloring test result with said respective color result reference on said reference holder for correctly interpreting said coloring test result.

27. The method, as recited in claim 26, wherein at least one of said urine testing pads contains chemistry reagent as said urine testing substance provided at said urine absorbing portion of said respective urine testing pad while another said urine testing pad contains immunoassay as said urine testing substance provided at said urine absorbing portion of said respective urine testing pad.

28. The method, as recited in claim 26, wherein each of said urine testing pads contains chemistry reagent as said urine testing substance provided at said urine absorbing portion of said respective urine testing pad.

29. The method as recited in claim 28, in step (b), further comprising the steps of:
(b.1) absorbing said tested urine by a single urine absorbing membrane integrally formed by said urine absorbing portions of said urine testing pads; and
(b.2) distributing said tested urine to react with said urine testing substances at said urine absorbing portions of said urine testing pads in a separated manner for performing different tests on said different urine absorbing portions.

30. The method as recited in claim 26, in step (b), further comprising the steps of:
(b.1) immersing spacedly opening slots of said reference holder into said tested urine to absorb said tested urine to said urine testing pad, wherein said urine testing substances are provided to react with said tested urine; and
(b.2) generating said coloring test result when said urine testing substance is chemically reacted with said tested urine.
